(19) United States
(12) Patent Application Publication
(10) Pub. No.: US 2024/0339722 A1
(43) Pub. Date: Oct. 10, 2024

(54) GAS DISCHARGE CHAMBER AND BATTERY ASSEMBLY FOR DISCHARGING GASES FROM A MOTOR VEHICLE BATTERY

(71) Applicant: AUDI AG, Ingolstadt (DE)

(72) Inventors: Carsten LORENZ, Reichertshofen (DE); Thomas MILDE, Wüstenrot (DE); Martin SCHÜSSLER, Kösching (DE)

(73) Assignee: AUDI AG, Ingolstadt (DE)

(21) Appl. No.: 18/700,050

(22) PCT Filed: Oct. 11, 2022
(86) PCT No.: PCT/EP2022/078177

§ 371 Date: Apr. 10, 2024

(30) Foreign Application Priority Data
Oct. 25, 2021 (DE) 102021127620.9

(51) Int. Cl. H01M 50/383; B60L 3/00; H01M 50/249; H01M 50/30; H01M 50/358

(52) U.S. Cl. CPC H01M 50/383; B60L 3/0046; H01M 50/249; H01M 50/358; H01M 50/394; H01M 2220/20

(57) ABSTRACT

A gas discharge chamber for discharging gases from a motor vehicle battery. A gas emerging from the motor vehicle battery and introduced into the gas discharge chamber through an inlet opening can be passed through this to an outlet opening. The gas discharge chamber has a gas discharge channel arranged in a first region of its interior, which has a partially gas-permeable channel wall which separates the first region from a second region of the interior into which the inlet opening opens, at least partially, and the outlet opening opens into an interior of the gas discharge channel in the first region. A gas permeability of the channel wall varies depending on a distance from the at least one outlet opening.

### FIELD

The invention relates to a gas discharge chamber for discharging gases from a motor vehicle battery with at least one first battery cell, wherein the gas discharge chamber has at least one chamber wall which separates an interior of the gas discharge chamber from an environment of the gas discharge chamber, at least one at least exposable first inlet opening, and at least one at least exposable outlet opening. The gas discharge chamber is designed in such a way that a gas emerging from the at least one first battery cell, which is introduced into the gas discharge chamber through the at least one inlet opening, can be passed through the gas discharge chamber to the at least one outlet opening and can be expelled from the at least one outlet opening. Furthermore, the invention also relates to a battery assembly with a gas discharge chamber.

### BACKGROUND

If a battery cell in a high-voltage battery malfunctions, particularly for a motor vehicle, harmful gases may escape from the battery cell. These harmful gases can ignite and cause damage to the entire high-voltage battery. It is therefore advantageous to discharge these harmful gases from the battery and from the motor vehicle in a targeted and safe manner. Various options are currently known for this purpose.

For example, DE 10 2012 214 984 A1 describes an exhaust gas guide device with a main guide piece, which is suitable for use in an exhaust system of a motor vehicle with an internal combustion engine and battery. The main guide piece comprises a jacket, an enclosed cavity, an inlet opening and an outlet opening arranged from the inlet opening in a main flow direction. The exhaust gas guide device also has a secondary piece which comprises a further jacket, a further enclosed cavity, an inlet opening and an outlet opening, wherein the outlet opening of the secondary guide piece is connected to a further inlet opening of the main guide piece. In this way, the degassing opening of the battery pack can be connected to the vehicle's exhaust system and battery outgassings can get into the exhaust system and ultimately out of the vehicle into the environment.

Furthermore, DE 10 2018 220 992 A1 describes a safety device for an electrochemical energy storage that has a bursting valve and a cooling device. Hot gases escaping through the bursting valve have to be cooled down quickly. For cooling, a cooling plate can be provided, which is also designed as a cooling plate of the battery pack, so that the escaping gas can be guided along the underbody of the vehicle or along the cooling plate of the battery pack.

Harmful gases escaping from battery cells should not only be able to be discharged from the battery and the vehicle, but they should also be defused as far as possible in terms of their danger potential during the degassing route, which in the examples mentioned above is done by providing cooling and by guiding them through an exhaust system is to be achieved.

Nevertheless, the desire to further increase safety in connection with the discharge of gases from a battery remains.

### SUMMARY

It is therefore the object of the present invention to provide a gas discharge chamber and a battery assembly which enable gases escaping from a battery cell to be discharged in the safest and most efficient manner possible.

A gas discharge chamber for discharging gases from a motor vehicle battery with at least one first battery cell has at least one chamber wall which separates an interior of the gas discharge chamber from an environment of the gas discharge chamber, at least one at least exposable first inlet opening, and at least one at least exposable outlet opening. The gas discharge chamber is designed in such a way that a gas emerging from the at least one first battery cell, which is introduced into the gas discharge chamber through the at least one inlet opening, can be passed through the gas discharge chamber to the at least one outlet opening and can be discharged from the at least one outlet opening. The gas discharge chamber has a gas distribution structure arranged in the interior of the gas discharge chamber, which is designed to distribute a gas introduced into the gas discharge chamber via the at least one first inlet opening before exiting the at least one outlet opening in the interior of the gas discharge chamber.

The invention is based on multiple findings at the same time: On the one hand, it is very advantageous not to discharge a gas to be discharged via a narrow channel or at least not exclusively via a narrow channel, but rather to use the largest possible volume for this purpose, as the one provided, as a whole, for example, through the gas discharge chamber. If a gas is introduced into such a gas discharge chamber with a large volume, the gas can expand and thereby cools down. This in turn is based on the knowledge that cooling the gas is very important in order to prevent the gas from spontaneously igniting when it outlets the gas discharge system. However, in order to be able to use the total volume provided by the gas discharge chamber as efficiently as possible to cool the introduced gas, it is advantageous to distribute the gas as widely and evenly as possible within this discharge chamber. If such a chamber only had an inlet opening and an outlet opening, the gas could take a very short flow path from the inlet opening directly to the outlet opening, which means that, depending on the positioning of the inlet and outlet openings relative to one another, the maximum volume provided by the chamber could not be used. This can now be advantageously changed by providing the gas distribution structure. This gas distribution structure, which can also have multiple individual gas distribution devices and/or gas distribution structural elements, can ensure distribution of the gas introduced into the gas discharge chamber before it leaves the interior again via the at least one outlet opening. This allows the gas discharge path through the interior to be fanned out in a targeted manner and distributed broadly and flatly, making the entire volume of the gas discharge chamber usable. Such a broad and extensive distribution can in turn ensure that the gas velocities and gas temperatures are reduced in order to effectively avoid ignition of the flammable hydrocarbon components and pure hydrogen at the system outlet point. Furthermore, the provision of the gas distribution structure also promotes the separation of particles carried in the gas. Such particles in particular are ignition sources when the gas outlets from the final outlet opening. Because this can also ensure that glowing particles are deposited or that these hot particles are also cooled when they hit the gas distribution structure, there are no longer any ignition sources at the outlet and the gas temperature is so low that spontaneous combustion can be ruled out. Another advantage of the gas distribution structure is that the gas distributing effect can also provide efficient gas cooling when passing through the gas discharge chamber to the outlet opening, regardless of the introduction position, namely the position of the inlet opening in relation to the interior. This also makes it possible, for example, to optionally introduce the gas via multiple inlet openings, e.g. those assigned to different battery modules. In addition, very homogeneous pressure conditions in the interior can be set by the gas distribution structure, as a result of which the gas discharge chamber can be designed to be less pressure-resistant overall and therefore simpler.

According to an advantageous embodiment of the invention, the gas distribution structure has at least one gas discharge channel arranged in a first region of the interior, which has at least one partially gas-permeable channel wall, which at least partially separates the first region from the second region of the interior, wherein the at least one first inlet opening opens into the second region of the interior and wherein the at least one outlet opening opens into an interior of the gas discharge chamber in the first region, in particular wherein the at least one channel wall is designed such that a gas permeability of the channel wall varies depending on a distance from the at least one outlet opening, for example by increasing with increasing distance. By means of such a gas discharge channel, gas distribution within the interior can be implemented in a particularly advantageous manner. This at least one gas discharge channel has at least one gas-permeable channel wall which separates a first region of the interior of the gas discharge chamber, in which the outlet opening is arranged, from a second region of the interior into which the inlet opening opens. In other words, a gas introduced into the gas discharge chamber through the inlet opening must first penetrate the gas-permeable channel wall in order to be able to reach the outlet opening. Because the gas permeability of the channel wall varies depending on a distance from the outlet opening, the path of the gas discharge path can advantageously be influenced. For example, if the inlet opening is located near the outlet opening, this can prevent the gas from flowing directly from the inlet opening to the outlet opening. For example, such a short direct path can be prevented by a reduced gas permeability of the channel wall in this region or can be correspondingly provided with greater flow resistance. This allows, for example, the flow path or the gas discharge path taken by the gas to be specifically designed and extended and, in particular, the gas discharge path can be specifically fanned out and distributed broadly and extensively, making the entire volume of the gas discharge chamber usable. Such a broad and extensive distribution can in turn ensure that the gas velocities and gas temperatures are reduced in order to effectively avoid ignition of the flammable hydrocarbon components and pure hydrogen at the system outlet point. Furthermore, such an additional, partially gas-permeable channel wall can be used to specifically separate particles carried in the gas, as already described above. Because this can also ensure that glowing particles are deposited or that these hot particles are also cooled when they hit the gas distribution structure, there are no longer any ignition sources at the outlet and the gas temperature is so low that spontaneous combustion can be ruled out. Another particularly great advantage of the invention is that by varying the gas permeability of the channel wall it can also be achieved that the function described is independent of the position of the at least one inlet opening. Regardless of whether the at least one inlet opening is arranged very close to the outlet opening or not, a suitable distribution of the gas in the gas discharge chamber can always be achieved. This also makes it possible, for example, to provide multiple inlet openings at different positions of the gas discharge chamber, whereby regardless of which of the inlet openings gas enters the gas discharge chamber, a similar cooling and spreading effect can always be achieved for the gas. This in turn makes it possible to provide the gas discharge chamber, for example, directly below or above a high-voltage battery of a motor vehicle and to couple the individual battery modules or cells to the gas discharge chamber via a direct supply connection. Gases from a battery cell can therefore be introduced into such a gas discharge chamber via the direct and shortest route. Regardless of the introduction position, efficient gas cooling can then be provided as it passes through the gas discharge chamber to the outlet opening.

A chamber wall is preferably understood to mean the spatial and structural limitation of the total volume of the gas discharge chamber. The chamber wall can therefore optionally also be divided into multiple individual chamber walls, as will be explained in more detail later. The at least exposable first inlet opening and also the outlet opening can be provided in the chamber wall. The gas discharge chamber can have not only a single inlet opening and a single outlet opening, but also optionally multiple inlet openings and optionally multiple outlet openings. The number of inlet and outlet openings can differ. An at least exposable inlet opening should generally be understood to mean an inlet opening that is either permanently open, for example a permanent hole in the chamber wall, or that is fundamentally closed and only opens under a certain condition, for example in the event of excess pressure, or depending on the temperature. The at least exposable inlet opening can, for example, only be exposed when the at least one first battery cell, which is assigned to the at least one first inlet opening, outgasses. The at least one at least exposable outlet opening can also be designed in such a way that it is either permanently present or is only exposed when the at least one first battery cell outgasses. The inlet or outlet opening can, for example, be designed as a pressure relief valve or bursting membrane or melting membrane.

Furthermore, the invention also relates to a battery assembly having a gas discharge chamber according to the invention or one of its embodiments. In addition to the gas discharge chamber, the battery assembly can also comprise the motor vehicle battery with the at least one battery cell. The motor vehicle battery can be designed, for example, as a high-voltage battery. The at least one battery cell can be formed, for example, as a lithium-ion cell. The motor vehicle battery can also comprise numerous battery cells, in particular multiple battery modules, each with multiple battery cells. A respective one of the battery cells, including the at least one first battery cell, can then have a corresponding exposable degassing opening, from which the gas can escape from the relevant battery cell in the event of degassing of the relevant battery cell. This can also be designed, for example, as a bursting membrane, pressure relief valve or similar.

The outlet opening of the gas discharge chamber can represent a final outlet opening from which the gas is ultimately discharged from the motor vehicle in which the gas discharge chamber is used. Alternatively, another gas discharge channel can be connected to the outlet opening, which discharges the escaping gas to a final outlet opening of the motor vehicle. This offers more flexibility with regard to the positioning of the at least one final outlet opening.

Furthermore, it is conceivable that the gas discharge channel only has a gas-permeable channel wall. The gas discharge channel can, for example, be defined as the entire first region of the interior, wherein the interior can only be divided into the first and second regions. The two regions are then separated accordingly by the gas-permeable channel wall. However, the gas discharge channel can also have two channel walls, in particular two such gas-permeable channel walls, so that the interior is divided by these gas-permeable channel walls, for example, into at least three sub-regions, one of which, namely the first region, represents the gas discharge channel itself. Multiple gas discharge channels can also be provided, as will be explained in more detail later. In an advantageous embodiment of the invention, the gas permeability of the channel wall varies depending on a distance from the at least one outlet opening in such a way that the gas permeability increases with increasing distance from the outlet opening. This is particularly advantageous because, for example, if the inlet opening is arranged near the outlet opening, separated from the gas-permeable channel wall, it is difficult for the gas to take the direct route to the outlet opening, since the gas permeability of the channel wall close to the outlet opening is lower. Here only a small amount of gas passes through the channel wall, which forces the gas to continue to flow along the channel wall and penetrate it elsewhere, which is easier for the gas as the distance to the outlet opening increases due to the increased gas permeability.

For example, it can be provided that the channel wall has a first wall region and a second wall region which is further away from the outlet opening than the first wall region, with a first gas permeability assigned to the first wall region being smaller than a second gas permeability assigned to the second wall region. In addition, it is also conceivable that the gas permeability within the respective wall regions also varies depending on the distance to the outlet opening. Alternatively, the channel wall can also be segmented into discrete wall regions within which the gas permeability is the same.

As a result, the flow resistance can be specifically set in the transverse flow direction, i.e. transversely, in particular perpendicular to a longitudinal direction of the gas discharge channel, and specifically differently depending on the distance to the at least one outlet opening. However, this can be achieved not only by a different or varying gas permeability of the at least one channel wall of the gas discharge channel but also additionally or alternatively by gas guiding structures, as these will be explained in more detail later. This means that the channel wall can also be designed with a constant, non-varying gas permeability, or with a gas permeability that can vary in certain regions, but does not necessarily have to vary depending on the distance to the at least one outlet opening. Different cross-flow resistances of the flow path in the direction defined above can be specifically provided by these gas guiding structures, which then, for example, offer more or less resistance to such a gas cross-flow depending on the distance to the outlet opening in the second direction.

In a further advantageous embodiment of the invention, the outlet opening is arranged at one end of the gas discharge channel with respect to a longitudinal direction of the gas discharge channel. This makes it possible to ensure that the path the gas has to take to reach the outlet opening is as long as possible. This in turn allows the gas to be cooled as efficiently as possible within the gas discharge chamber. Nevertheless, it would also be conceivable for the outlet opening to be arranged at a different position in the gas discharge channel, for example in the middle. Furthermore, it is preferred that only a single outlet opening is provided for each gas discharge channel. This ensures defined flow conditions within the gas discharge chamber.

Furthermore, according to an advantageous embodiment of the invention, it is provided that the chamber wall comprises a first and a second chamber wall, which are opposite one another with respect to a first direction and delimit the gas discharge chamber in the first direction and against the first direction. These two first and second walls are preferably the largest walls of the gas discharge chamber in terms of surface area. With regard to the intended installation position of the gas discharge chamber in a motor vehicle, it is preferred that the first direction corresponds to a vertical direction of the vehicle. Furthermore, it is advantageous if the gas discharge channel extends in a longitudinal direction that is perpendicular to the first direction, and wherein the at least one channel wall is arranged between the first and second chamber walls and connects the first and second chamber walls to one another. The longitudinal extension direction or longitudinal direction of the gas discharge channel can, for example, run in a second direction that is perpendicular to the first direction. In particular, the gas discharge channel can, for example, run in a straight line in this second direction. In principle, however, it is also conceivable that the gas discharge channel does not run in a straight line, but rather, for example, in a serpentine shape or something similar. However, this is less preferred. Furthermore, the chamber wall can also comprise a third and a fourth chamber wall, which delimit the gas discharge chamber with respect to said second direction, which is perpendicular to the first direction, the gas discharge channel running from the third chamber wall to the fourth chamber wall. In other words, the gas discharge channel may extend over an entire length of the gas discharge chamber in the second direction. By means of the at least one gas-permeable channel wall, the gas distribution within the gas discharge chamber can advantageously be controlled in a targeted manner over its entire length due to the varying gas permeability. The gas discharge chamber can generally be designed, for example, in such a way that its interior is divided into multiple individual regions, which are separated from one another by a plurality of channel walls running in the second direction and which are designed to be gas-permeable, in particular as described for at least one gas-permeable channel wall of the gas discharge channel. The individual regions are in turn divided into regions that define a gas discharge channel and in each of which an outlet opening is provided. The remaining regions between these gas discharge channels are gas inlet regions in which gas inlet openings can be provided. With respect to the first direction, a respective gas discharge channel is also delimited by the first chamber wall and the second chamber wall. Perpendicular to the first direction, the gas discharge channel is delimited accordingly by its respective gas-permeable channel walls. However, it is also conceivable that a gas discharge channel is located in an edge region of the gas discharge chamber, so that a chamber wall also represents a channel wall. This does not necessarily have to be gas-permeable, for example, but can be completely gas-impermeable. Furthermore, it is preferred that the interior of the gas discharge chamber has a height in the first direction that is significantly smaller than all other dimensions of the interior of the gas discharge chamber in the second and a third direction perpendicular to the first and second direction. For this purpose, the extent of the gas discharge chamber in these second and third directions can be very large and, for example, extend over almost the entire underbody region of the motor vehicle.

Therefore, it represents a further particularly advantageous embodiment of the invention if at least part of the chamber wall is provided by an underride guard for a motor vehicle. Thus, the region between the motor vehicle battery, in particular its underside, and the underride guard of the motor vehicle can be used as such a gas discharge chamber in a particularly advantageous manner. This region represents a particularly large volume, which can therefore be used advantageously to integrate the at least one gas discharge channel there and to enable a wide and extended distribution of the gas over a very large overall volume. In addition, existing structures of the motor vehicle can be used to design such a gas discharge chamber. In addition, such a gas discharge chamber can then be integrated into a motor vehicle in a particularly space-efficient manner. The underride guard can, for example, represent one of the first or second chamber walls described above. If the underride guard provides at least a part of the first chamber wall, the second opposite chamber wall is preferably provided by a part of a battery housing of the motor vehicle battery, in particular a housing base. It is therefore preferred that the motor vehicle battery is arranged above the gas discharge chamber in its intended installation position.

The different gas permeabilities of at least one channel wall can now be provided in different ways. For example, it can be provided that the first wall region is designed to be gas-impermeable and is arranged at the end of the gas discharge channel comprising the outlet opening. In other words, the region of the channel wall that directly adjoins the outlet opening can be completely gas-tight. Alternatively, this wall region directly adjoining the outlet opening can also be designed with at least low gas permeability. The first wall region may, for example, extend over a length in the second direction which is at least one quarter of the total length of the interior of the gas discharge chamber in the second direction.

In a further advantageous embodiment of the invention, the second wall region has gas-permeable holes, with a mean passage region provided by the holes and related to a partial region of the second wall region increasing as the distance from the outlet opening increases. This can be provided in the simplest way, for example, in that the holes, which can be arranged next to one another in the channel wall in the second direction, for example, have an ever-increasing hole diameter as the distance from the outlet opening increases. Such hole diameters can be in the single-digit or multi-digit millimeter range. However, the channel wall can also be provided with finer structures in order to provide varying gas permeability. For example, the channel wall, for example the second wall region, can be designed as a type of net or grid, in particular metal grid, or as a porous metal foam or similar. The gas permeability can also be easily controlled and suitably adjusted by the sizes of the pores of such a foam or the spaces in such a network or grid. The holes mentioned above can basically have any hole geometries, for example round, square, elongated or similar.

In a further advantageous embodiment of the invention, the gas distribution structure has a plurality of gas discharge channels comprising the at least one gas discharge channel, wherein the gas discharge channels are arranged at a distance from one another, for example in the third direction defined above, wherein an outlet opening of a plurality of outlet openings of the gas discharge chamber opens into each gas discharge channel, and wherein a respective gas discharge channel has two gas-permeable channel walls opposite one another in the third direction. The gas discharge channels can, for example, run parallel to one another in the second direction. The regions in which the gas discharge channels are arranged can, for example, be defined as respective first regions of the interior of the gas discharge chamber, while the remaining regions are defined as second regions of the interior. Two second regions are therefore separated by a first region with a gas discharge channel, and two first regions in which two gas discharge channels are arranged are each separated by an intermediate first region of the interior of the gas discharge chamber. The outlet openings of the gas discharge chamber are arranged exclusively within the gas discharge channels, with preferably only one outlet opening being provided within a respective gas discharge channel. One or more inlet openings can open into the intermediate second regions of the interior. This makes it possible to achieve a particularly homogeneous and uniform distribution of the gas introduced into the chamber. This leads to a particularly homogeneous pressure distribution within the gas discharge chamber, which allows it to be designed for lower pressures overall.

In a further very advantageous embodiment of the invention, the gas discharge chamber has at least one exposable second inlet opening at a position different from the first inlet opening, the second inlet opening, opening into the second region of the interior, in particular wherein the second inlet opening is associated with the second battery cell different from the at least one first battery cell. The gas from the first battery cell can therefore be introduced into the gas discharge chamber, for example, via the first inlet opening, and the gas which emerges from a second battery cell that is different from the first battery cell and which can, for example, be part of another battery module of the battery, can be introduced via the second inlet opening into the gas discharge chamber, and thus at a different inlet position. The design of the gas discharge chamber always makes it possible to provide a particularly uniform distribution of the gas within the entire gas discharge chamber, regardless of the inlet position, and thus particularly efficient gas cooling until the gas exits from the at least one outlet opening. The respective inlet openings are preferably arranged in the above-mentioned second chamber wall, which can be provided, for example, by a housing base of a battery housing. The outlet openings are preferably arranged on a wall of the gas discharge chamber that is different from this second chamber wall.

Because, for example, a separate inlet opening can be provided per battery cell or per battery module of the motor vehicle battery, it can also be achieved that the paths from a relevant battery to the gas discharge chamber for a respective battery cell or a respective battery module can be minimized. This is particularly advantageous because the gas can be defused particularly quickly in terms of its potential danger.

According to a further very advantageous embodiment of the invention, a plurality of gas guiding structures are arranged within the gas discharge channel as part of the gas distribution structure to influence a flow path of the gas flowing in the gas discharge chamber. This has the great advantage that the gas can also be guided, deflected and distributed in a targeted manner through such structures. Such structures not only have a gas-guiding effect, but also a braking effect, as the gas inevitably collides with these structures. A targeted, additional particle separation can therefore also be achieved using such a gas guiding structure.

According to a further very advantageous embodiment of the invention, the gas guiding structures are designed such that they at least partially brake a gas flowing through the at least one channel wall, and/or that they at least partially deflect a gas flowing through the at least one channel wall in the longitudinal direction of the gas discharge channel, and/or that they deflect a gas flowing in the longitudinal direction of the gas discharge channel within the gas discharge channel multiple times in and/or against at least one deflection direction, which forms an angle with the longitudinal direction. In order to at least partially brake a gas flowing through the at least one channel wall, a structure can be provided which is designed, for example, in the form of a web which extends from the first to the second chamber wall or even only partially extends in this direction, and which also has an extension in the second direction. In other words, such a web can be designed in the form of a plate that is oriented perpendicular to the third direction. Gas that flows through the channel wall in the third direction thus impacts this plate or this web and is thereby slowed down. However, such a plate can also enclose an angle with the third direction that is different from 90 degrees and 0 degrees. The closer this angle is to 0 degrees or 180 degrees, the lower the braking effect. If this angle is, for example, 45 degrees, not only a braking effect can be achieved, but also, for example, a deflecting effect in the second direction. Such oblique plate portions, which therefore have a certain inclination to the longitudinal direction of the gas discharge channel, not only provide a braking effect of the gas that is currently flowing through the channel wall, but also a deflecting effect of the gas that is currently flowing along the gas discharge channel. For example, by such webs or plates aligned alternately along the gas discharge channel with respect to the angle of inclination, a deflection effect of the gas flowing along this channel can be achieved, which, for example, leads to a wave-shaped gas discharge path within the gas discharge channel. A respective plate can also be curved in a cross section perpendicular to the first direction, for example in the shape of a circular arc, and have a step parallel to the third direction, which merges into a portion parallel to the second direction through a curvature. Numerous such plates or gas guiding structures can also be arranged in the gas discharge channel, in particular in multiple rows spaced apart from one another in the third direction, for example in two or three rows per gas discharge channel. The arrangement of the plates within a row can be offset from row to row, so that the through openings formed in the longitudinal direction, i.e. in the second direction, of a row by the distance between two gas guiding structures are arranged offset from one another in the third direction. The distances between these gas guiding elements in the second direction or the size or length of these gas guiding elements can also vary in the second direction. The design and geometry of the gas guiding elements can also vary in the second direction. As a result, the cross-flow resistance can also be influenced and specifically adjusted by the gas guiding elements in the second direction.

Such a wave-shaped or zigzag-shaped deflection within the gas discharge channel as described above can also be achieved, for example, by arranging the gas guiding structures themselves in a zigzag or wave-shaped manner with respect to their course in the second direction and, for example, parallel to one another in the third direction. The gas or its flow can thus be channeled again within the gas discharge channel in order to redirect it multiple times. This efficiently extends the gas path, achieves increasing gas cooling and also promotes particle separation. Because the gas increasingly impacts on such gas-guiding structures, which consequently heat up, thermal energy can be transferred to these structures in an efficient manner. This in turn leads to the cooling of the gas. Furthermore, various such gas guiding structures can also be provided within a gas discharge channel, which in particular have different geometries and/or fulfill different of the functions mentioned. It can also be provided that such gas guiding structures are provided within the gas discharge channel over its entire length in the second direction or only over part of its length in the second direction. This provides numerous options for specifically influencing the gas flow.

If the gas discharge chamber has not just one gas discharge channel, but multiple gas discharge channels, these further gas discharge channels can be designed in the same way as described for the at least one gas discharge channel. If the gas discharge channel or the other gas discharge channels have not only one gas-permeable channel wall, but multiple, in particular two, gas-permeable channel walls, these can also be designed as described for the at least one gas-permeable channel wall of the at least one gas discharge channel.

Furthermore, the invention also relates to a battery assembly for a motor vehicle having a gas discharge chamber according to the invention or one of its embodiments. The advantages mentioned for the gas discharge chamber according to the invention and its embodiments thus apply equally to the battery assembly according to the invention. The battery assembly according to the invention additionally has the motor vehicle battery, which can be designed as described above.

Furthermore, a motor vehicle with such a battery assembly should also be regarded as belonging to the invention.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that respectively have a combination of the features of multiple of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic cross-sectional illustration of a battery assembly with a gas discharge chamber according to an exemplary embodiment of the invention;

FIG. 2 shows a schematic representation of a gas discharge chamber in a top view with gas entering through a first inlet opening according to an exemplary embodiment of the invention;

FIG. 3 shows a schematic representation of a gas discharge chamber in a top view with gas entering through a second gas inlet opening according to an exemplary embodiment of the invention;

FIG. 4 shows a schematic representation of a part of a gas discharge chamber in a top view of a part of a gas discharge channel according to an exemplary embodiment of the invention;

FIG. 5 shows a schematic representation of a part of a gas discharge chamber in a top view on a gas discharge channel according to another exemplary embodiment of the invention;

FIG. 6 shows a schematic representation of a part of the gas discharge chamber in a top view with gas guiding structures integrated into the gas discharge channel according to an exemplary embodiment of the invention;

FIG. 7 shows a schematic representation of a part of the gas discharge chamber in a top view with gas guiding structures integrated into the gas discharge channel according to a further exemplary embodiment of the invention;

FIG. 8 shows a schematic representation of a part of a gas discharge chamber in a top view on a gas discharge channel with wave-like gas guiding structures according to another exemplary embodiment of the invention;

FIG. 9 shows a schematic representation of a part of a gas discharge chamber in a top view on a gas discharge channel with longitudinally directed gas guiding structures according to another exemplary embodiment of the invention; and

FIG. 10 shows a schematic representation of a gas discharge chamber in a top view with multiple gas discharge channels, in which different gas guiding structures are integrated, according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

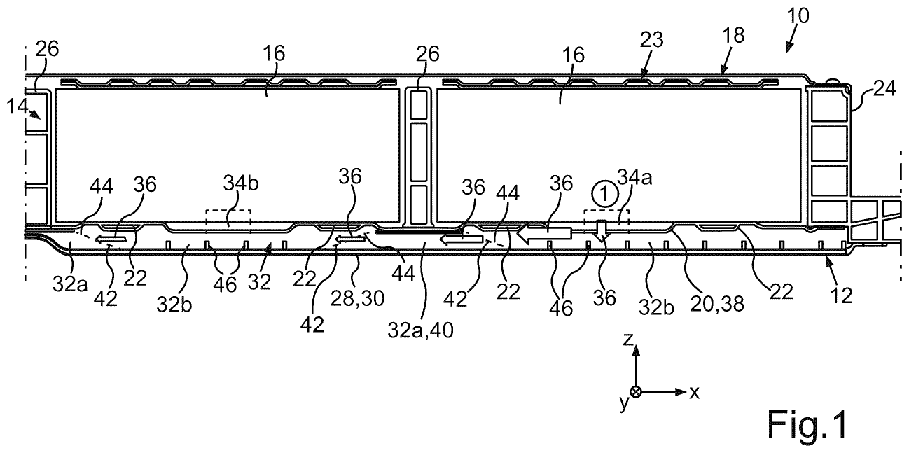

FIG. 1 shows a schematic illustration of a battery assembly 10 with a gas discharge chamber 12 according to an exemplary embodiment of the invention. The battery assembly 10 has a battery 14, which is preferably designed as a high-voltage battery 14. This battery 14 in turn comprises multiple battery modules 16, each of which can comprise multiple battery cells. Two of the battery modules 16 are shown here as examples. However, the battery 14 can also comprise far more than two battery modules 16. The battery 14 can also only have a single battery module 16. The battery modules 16 are further arranged in a battery housing 18 of the battery. The housing 18 has a housing base 20, which in this example is additionally designed as a cooling base and, for example, comprises cooling channels 22 through which a cooling medium can flow. In this example, a further cooling system 23 is also arranged above the battery modules 16, which can also be designed with cooling channels through which a cooling medium can flow. The battery housing 18 also comprises side walls 24 and partition walls 26 between respective receiving regions for receiving the battery modules 16. The z direction shown preferably corresponds to a vehicle vertical direction when the battery assembly 10 is installed in a vehicle as intended. In this example, the gas discharge chamber 12 is arranged below the battery 14 with respect to the z-direction. The underside wall 28, which delimits the gas discharge chamber 12 or its interior 32 downwards, also represents an underride guard 30 of the motor vehicle. The available installation space between the battery 14 and the underride guard 30 can therefore advantageously be used as such a gas discharge chamber. The gases emerging from battery cells of the battery modules 16 can be introduced into the gas discharge chamber 12 via an extremely short path. To allow gas entry, the gas discharge chamber 12 has at least one inlet opening 34a, 34b. In the present example, each of the battery modules 16 is assigned a corresponding inlet opening 34a, 34b. If, for example, the right battery module 16 shown here or a cell encompassed by it outgasses, the gas 36, which emerges from this cell and is illustrated here by arrows, can be introduced into the gas discharge chamber 12 via the assigned first inlet opening 34a. The same applies if a cell of the other battery module 16, in this example on the left, outgasses, then its gas would be introduced into the gas discharge chamber 12 via the second inlet opening 34b. These inlet openings 34a, 34b can be designed as exposable inlet openings, that is, they do not have to be provided by permanent openings, but can, for example, only be exposed in the event of outgassing of an assigned battery cell. Theoretically, it is also conceivable to provide more than just one inlet opening 34a per battery module 16, for example also per battery cell of such a battery module 16. However, more than one inlet opening 34a, 34 can also be provided per battery module 16, but fewer inlet openings 34a, 34b per battery module 16 be comprised as battery cells by this battery module 16.

The gas discharge chamber 12 is generally delimited upwards and downwards by two chamber walls, namely an already mentioned lower chamber wall 28, which is provided by the underride guard 30, and a further upper chamber wall 38, which at the same time represents the housing underside 20 of the battery housing 18. Further chamber walls can also be provided in and against the x direction and in and against the y direction, which delimit the gas discharge chamber 12 in the corresponding directions.

The interior 32 of the gas discharge chamber 12 is now divided into multiple regions 32a, 32b. The regions 32a are referred to as first regions 32a, and the other regions 32b as second regions 32b. First and second regions 32a, 32b alternate in the x-direction and extend in the y-direction, preferably over the entire length of the interior 32. The first regions 32a simultaneously define gas discharge channels 40. A respective gas discharge channel 40, which is also partly described below simply as channel 40, also has at least one, preferably two, gas-permeable channel walls 42. A respective channel wall 42 thus separates a first region 32a from the adjacent second region 32b in or against the x-direction. The gas permeability of the respective channel walls 42 can be provided in a variety of ways, for example through holes 44 in the channel wall 42. As can be seen in this cross-sectional view in FIG. 1, these channel walls 42 run from the lower chamber wall 28 to the upper chamber wall 38, preferably not parallel to the z-direction, but at an angle. As a result, these gas discharge channel walls 42 can advantageously take on a dual function in combination with the underride guard 30. If force is applied to the underride guard 30 from below in the direction of the battery 14, these oblique channel walls 42 can be used to achieve a targeted force deflection and introduction into the separating webs 26 or into the sides 24, so that overall the force applied to the battery modules 16 can be held as low as possible. However, this function does not necessarily have to be realized by this oblique course of the channel walls 42, but can also be realized, for example, by a certain dense composition or material composition of the channel walls 42. The gas discharge channels 40 or the first regions 32a are preferably arranged below the separating webs 26 and/or side walls 24 of the battery housing 18 with respect to the z direction. This also provides optimal protection for the battery modules 16 in the event of any force being applied or in case of any intrusion from below onto the underride guard 30.

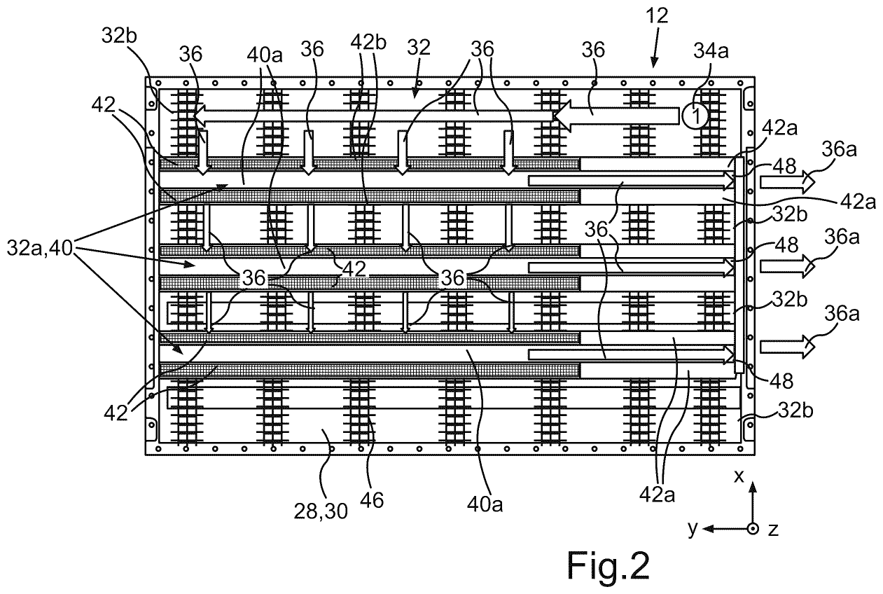

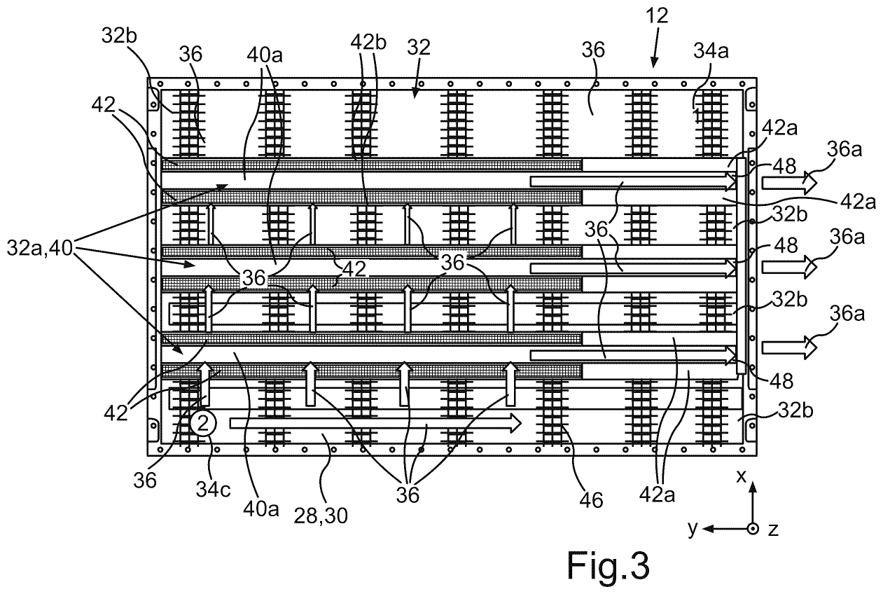

In addition, structures 46 which perform a dual function are also arranged in the second regions 32b of the interior 32 of the chamber 12. On the one hand, these structures 46, which can be designed in particular as arcuate webs, can in turn take on a specific support and force introduction function, especially in the case of an application of force to the underride guard 30 from the underside, in order to distribute the acting forces as well as possible and to avoid a locally high force on a battery module 16. In addition, these structures 46 are designed in such a way that a gas can flow over them in the x-direction and at the same time a gas flow in the y-direction is also possible. In addition, they can achieve a certain gas-braking effect, especially in the x-direction or against the x-direction, which in turn contributes to slowing down the gas flow and thus cooling the gases. The arrows 36 illustrating the gas 36 become increasingly smaller as they run along a flow path, which is intended to illustrate that the gas flow 36 emerging from the inlet opening 34a is increasingly distributed over the entire internal volume of the chamber 12. This is explained more clearly with reference to FIGS. 2 and 3.

FIG. 2 shows a schematic representation of the gas discharge chamber 12 in a top view. In particular, FIG. 2 shows a view into the interior 32 of the chamber 12 without the upper wall 38 of the chamber 12 being shown. In this example, the chamber 12 exemplarily comprises three gas discharge channels 40 in respective first regions 32a of the interior 32 of the chamber 12. The interior of a respective channel 40 is also designated 40a. The interior regions 32b lying between the channels 40 therefore represent the second regions 32b of the interior 32. The first inlet opening 34a is illustrated by a circle in FIG. 2. In order to discharge the gas 36 introduced into the chamber 12 through the inlet opening 34a from the chamber 12 again, the chamber 12 has a corresponding outlet opening 48 for each gas discharge channel 40. A respective outlet opening 48 is arranged at one end of a respective channel 40 in relation to a second direction, which corresponds to the y-direction shown here. With respect to the y-direction and with respect to the intended installation position of the gas discharge chamber 12 in a motor vehicle, the outlet openings 48 are also preferably arranged at an end of the gas discharge chamber 12 that points towards the rear of the vehicle. This makes it particularly easy to direct the discharged gases 36a to a final outlet position in the rear region of the vehicle. The channel walls 42 are shown correspondingly wide in the plan view in FIG. 2 due to their oblique course in the z direction, as shown in FIG. 1.

Due to the gas permeability of the channel walls 42, the gas 36 flowing into the chamber 12 through the inlet opening 34a, in particular into a second region 32b, can penetrate into the respective gas discharge channels 40. The gas 36 can not only penetrate into them, but can also flow therethrough perpendicular to its course in or against the y-direction, that is to say in or against the x-direction. This advantageously allows the gas 36 to be distributed over the entire volume of the chamber 12. This distribution should be as homogeneous as possible, so that almost constant pressure conditions are achieved over the entire chamber 12. It should also be avoided that the gas 36, which in the present example enters the chamber 12 very close to an outlet opening 48, is discharged again directly via such an outlet opening 48. This can now advantageously be accomplished in that the channel walls 42 are not designed to be homogeneous or isotropically gas-permeable, but rather in that the gas permeability of these channel walls 42 varies depending on the distance to the outlet openings 48 of a respective channel 40, in particular increasing with increasing distance. In the present example, a respective channel wall 42 has a first wall region 42a and a second wall region 42b. The first wall region 42a is closer to an outlet opening 48 of the same channel 40 to which the first wall region 42a is also assigned. Accordingly, the gas permeability in the first wall region 42a is lower than in the second wall region 42b. In particular, in this example, the first wall region 42a is completely gas-tight, for example designed as a solid wall or sheet metal, while only the second wall region 42b is gas-permeable. A particularly uniform distribution of the gas over the entire interior 32 can thus be achieved. The gas entering through the inlet opening 34a cannot therefore flow directly to an outlet opening 48, but first flows along the y-direction and then passes through the respective channel walls 42, in particular in the respective second regions 42b, and is thus distributed over the multiple gas discharge channels 40, flows along these to the respective outlet opening 48 and then leaves the chamber 12. The outflowing harmful gas, which is designated 36a here, is significantly cooled and contains fewer or no particles. Spontaneous combustion or fire from the battery system is thus eliminated or the risk is significantly reduced.

FIG. 3 shows again a schematic representation of the gas discharge chamber 12 from FIG. 2, which can in particular be designed in the same way as described for FIG. 2 and FIG. 1. In this example, however, the gas enters the chamber 12 in a different position, namely through a further inlet opening 34c. The gas flowing through chamber 12 is again designated 36. For reasons of clarity, not all arrows illustrating the gas 36 are provided with a reference number. Although the gas 36 enters the chamber 12 at a different location or inlet position, the structures described can also achieve a uniform distribution of the gas 36 over the entire chamber interior 32. It is therefore advantageously possible, regardless of the inlet position, to effect a particularly wide, extended and homogeneous distribution of the gas 36 over the entire interior 32 before the gas 36 leaves the chamber 12 again via the outlet openings 48. This allows the gas to be cooled to the maximum and numerous particles can be separated.

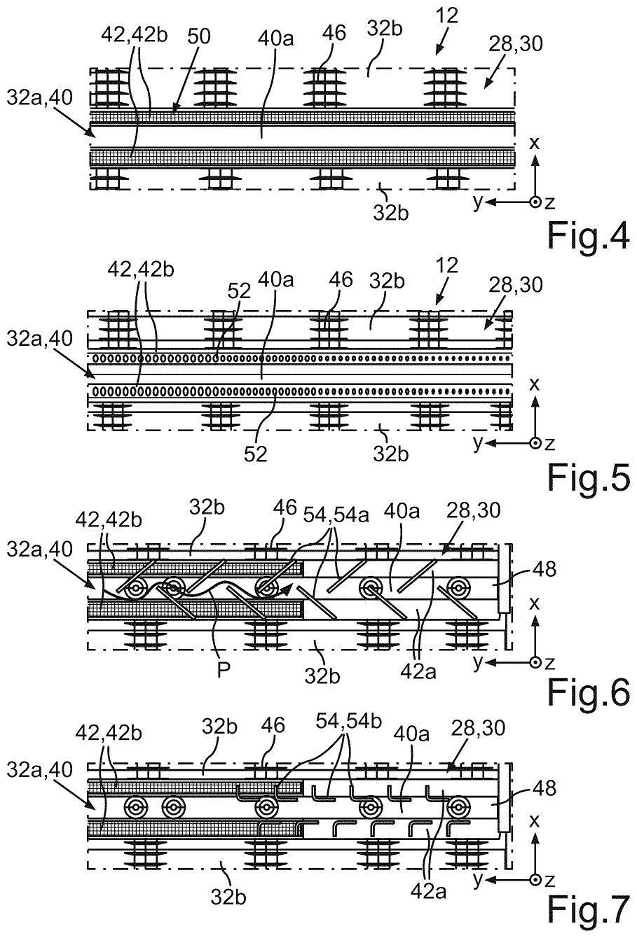

The different gas permeabilities of the walls 42 can be implemented in different ways, as will now be described with reference to FIGS. 4 and 5.

FIGS. 4 and 5 each show a schematic representation of a part of the chamber 12 in a top view of a part of a respective gas discharge channel 40. The channel walls 42 of the channel 40 are formed with a type of net structure 50 in the example shown in FIG. 4. This net structure 50 ensures a certain degree of gas permeability, at least in the second wall region 42b. The channel walls 42 can, for example, be designed in such a way that they are completely gas-impermeable in the first wall region 42a (see FIG. 2) and are gas-permeable in the second wall region 42b, as shown for example in FIG. 4, in particular with a constant gas permeability in y-direction. Alternatively, the gas permeability can also vary in the second wall region 42b depending on the distance to the outlet opening 48 (see FIG. 2). This can be accomplished, for example, by an inhomogeneous design of this net structure 50, or also by holes 52 of different sizes, as shown in FIG. 5. FIG. 5 shows another example of the design of the channel walls 42. As can be seen, the channel walls 42 in this example have holes 52 which become larger in diameter in the y-direction and thus with increasing distance from the outlet opening 48. This can ensure that the average gas passage area becomes larger and larger as the distance from the outlet opening 48 of the relevant channel 40 increases. In addition, numerous other configurations of these channel walls 42 are also conceivable in order to realize different gas permeabilities in different wall regions 42a, 42b or within such a wall region 42b.

Furthermore, it is particularly advantageous if gas guiding structures are arranged within the gas discharge channels 40, as will now be explained in more detail below.

For this purpose, FIG. 6 shows a first example of such gas guiding structures 54 in a gas discharge channel 40 according to an exemplary embodiment of the invention. Here again, a part of such a channel 40 is shown in a top view. In this example, these gas guiding structures 54 are designed as inclined webs 54a. These webs 54a correspondingly form an angle with the longitudinal direction of the channel 40, which extends in or against the y-direction, as well as an angle with the x-direction. This allows multiple functions and modes of operation to be implemented at the same time. A gas flowing along the channel 40 is deflected multiple times by these structures 54, in particular in a wave-like or zigzag shape, in order to be able to reach the outlet opening 48. This is exemplified by the gas discharge path P shown. In addition, the gas, which passes through the channel walls 42 in or against the x direction, is braked when it hits these structures 54. This causes additional particles to be separated and the gas to be slowed down, which leads to the gas cooling down.

FIG. 7 illustrates a further example of such gas guiding structures 54, which, as shown in FIG. 7, are designed as curved webs 54b. Gas which, for example, flows along the gas discharge channel 40 can thus be efficiently prevented from escaping from this gas discharge channel 40 again. Conversely, gas that penetrates the walls 42 is directed in the direction of the channel 40 in the direction of the outlet opening 48. A straight flow through both channel walls 42 of the channel 40 can thereby be prevented or reduced in extent.

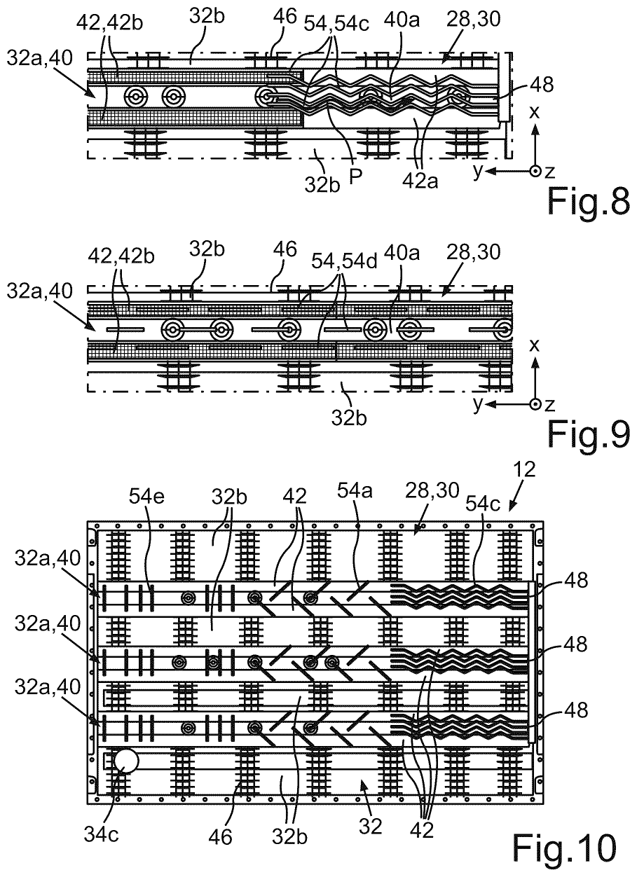

FIG. 8 shows another example of such gas guiding structures 54, which run as zigzag-shaped or wave-shaped structures in the channel direction. This can also ensure that the gas 36 flowing in the channel 40 is guided along a wave-shaped path P. This also means that the gas 36 is redirected multiple times, whereby increasing cooling and particle separation can be achieved.

FIG. 9 shows a further example of such gas guiding structures 54 in the form of webs 54d running in the channel direction. The gas flowing through the channel walls 42, i.e. against the x-direction or in the x-direction, can thereby be efficiently slowed down. This in turn increases the particle separation, slows down the gas, and in addition, such structures 54d can also be used to control the proportion of gas that is to be introduced into the corresponding channels 40. It can thus be achieved that the gas 36 is distributed as evenly as possible among the multiple channels 40 when flowing through in or against the x direction.

The structures can generally be arranged both in a channel region which corresponds to the first wall region 42a with respect to the y-direction, as well as in a channel region which corresponds to the second wall region 42b with respect to the y-direction, or only in one of both channel regions of channel 40.

In addition, the described structures 54 can be combined in any way within the same channel 40 or different structures 54 can be provided for different channels 40. The structures can extend over the entire length of the channel 40 in the y direction or only a part of it. The possible combinations of these structures are again explicitly illustrated in FIG. 10.

FIG. 10 again shows a schematic representation of a gas discharge chamber 12 in a top view. Here, different structures 54 are shown for the respective channels 40, in particular wave-shaped structures 54c, oblique webs 54a, and also vertical webs 54e that have not been explained before, through which, for example, a targeted gas deflection through the channels 40 can be achieved. Many other structures 54 are also conceivable. Another major advantage of such structures is that the stability in relation to the underride guard 30 can be additionally increased. This applies not only to these gas guiding structures 54, but also, for example, to the channel walls 42. Overall, the deflection plates can be used to improve the structural connection of the underride guard 30 to the battery system 14, for example the frame 24. This is particularly helpful in the event of damage to the underbody region, such as a bollard falling.

Overall, the examples show how the invention provides harmful gas management in the event of a thermal runaway, which enables hot gas to be diverted in the region of the underride guard via guiding plates and perforated plates. As a result, glowing particles are deposited or these hot particles cool down when they hit the guiding and perforated plates. There are no longer any sources of ignition at the outlet from the underride guard and the gas temperature is so low that spontaneous combustion can preferably be ruled out. The design can be such that the function is independent of the position of the thermal runaway cell in the battery system or the inlet opening.

1-10. (canceled)

11. A gas discharge chamber for discharging gases from a motor vehicle battery with at least one first battery cell, wherein the gas discharge chamber
has at least one chamber wall which separates an interior of the gas discharge chamber from an environment of the gas discharge chamber, and which comprises a first and second chamber wall, which lie opposite one another with respect to a first direction and delimit the gas discharge chamber in the first direction and against the first direction,
has at least one at least exposable first inlet opening;
has at least one at least exposable outlet opening,
is designed in such a way that a gas emerging from the at least one first battery cell, which is introduced into the gas discharge chamber through the at least one inlet opening, can be guided through the gas discharge chamber to the at least one outlet opening and can be discharged from the at least one outlet opening; and
has a gas distribution structure arranged in the interior of the gas discharge chamber, which is designed to distribute a gas introduced into the gas discharge chamber via the at least one first inlet opening before exiting the at least one outlet opening, in the interior of the gas discharge chamber;
wherein the gas distribution structure has at least one gas discharge channel arranged in a first region of the interior, which has at least one partially gas-permeable channel wall which at least partially separates the first region from a second region of the interior,
wherein the gas discharge channel extends in a longitudinal direction, which runs in a second direction, and which is perpendicular to the first direction,
wherein the gas discharge channel has two gas-permeable channel walls, so that the interior is divided by these gas-permeable channel walls into at least three sub-regions, of which one, which represents the first region, represents the gas discharge channel,
wherein one of the two gas-permeable channel walls is the at least one partially gas-permeable channel wall,
wherein the two gas-permeable channel walls delimit the gas discharge channel perpendicularly to the first direction,
wherein the two channel walls are respectively arranged between the first and second chamber wall and connect the first and second chamber wall to each other, and
wherein at least one first inlet opening opens into the second region of the interior, characterized in that
the at least one outlet opening opens into an interior of the gas discharge channel in the first region, and
a respective channel wall is designed such that a gas permeability of the respective channel wall varies depending on a distance from the at least one outlet opening in such a way that the gas permeability increases with an increasing distance from the outlet opening.

12. The gas discharge chamber according to claim 11, wherein the channel wall has a first wall region and a second wall region which is farther away from the outlet opening than the first wall region, wherein a first gas permeability assigned to the first wall region is smaller than a second gas permeability assigned to the second wall region.

13. The gas discharge chamber according to claim 11, wherein the chamber wall comprises a third and a fourth chamber wall which delimit the gas discharge chamber with respect to the second direction which is perpendicular to the first direction, wherein the gas discharge channel extends from the third chamber wall to the fourth chamber wall.

14. The gas discharge chamber according to claim 11, wherein at least part of the chamber wall is provided by an underride guard for a motor vehicle.

15. The gas discharge chamber according to claim 12, wherein the second wall region has gas-permeable holes, wherein an average passage region provided by the holes related to a partial region of the second wall region increases as the distance from the outlet opening increases.

16. The gas discharge chamber according to claim 11, wherein the gas distribution structure has multiple gas discharge channels comprising the at least one gas discharge channel, wherein the gas discharge channels are arranged at a distance from one another, wherein one outlet opening of multiple outlet openings in each gas discharge channel opens into the gas discharge chamber, wherein a respective gas discharge channel has two gas-permeable channel walls lying opposite one another in the third direction.

17. The gas discharge chamber according to claim 11, wherein the gas discharge chamber has at least one exposable second inlet opening at a position different from the first inlet opening, wherein the second inlet opening opens into the second region of the interior, in particular wherein the second inlet opening is associated with at least one second battery cell that is different from the at least one first battery cell.

18. The gas discharge chamber according to claim 11, wherein multiple gas guiding structures are arranged within the gas discharge channel to influence a flow path of the gas flowing in the gas discharge chamber, wherein the gas guiding structures are designed such that
they at least partially decelerate a gas flowing through the at least one channel wall; and/or
they at least partially deflect a gas flowing through the at least one channel wall into the longitudinal direction of the gas discharge channel; and/or
they deflect a gas flowing in the longitudinal direction of the gas discharge channel within the gas discharge channel multiple times in and/or against at least one deflection direction, which forms an angle with the longitudinal direction, for example in a wave-like manner.

19. A battery assembly for a motor vehicle with a gas discharge chamber according to claim 11 and with a motor vehicle battery.

20. The gas discharge chamber according to claim 12, wherein the chamber wall comprises a third and a fourth chamber wall which delimit the gas discharge chamber with respect to the second direction which is perpendicular to the first direction, wherein the gas discharge channel extends from the third chamber wall to the fourth chamber wall.

21. The gas discharge chamber according to claim 12, wherein at least part of the chamber wall is provided by an underride guard for a motor vehicle.

22. The gas discharge chamber according to claim 13, wherein at least part of the chamber wall is provided by an underride guard for a motor vehicle.

23. The gas discharge chamber according to claim 13, wherein the second wall region has gas-permeable holes, wherein an average passage region provided by the holes related to a partial region of the second wall region increases as the distance from the outlet opening increases.

24. The gas discharge chamber according to claim 14, wherein the second wall region has gas-permeable holes, wherein an average passage region provided by the holes related to a partial region of the second wall region increases as the distance from the outlet opening increases.

25. The gas discharge chamber according to claim 12, wherein the gas distribution structure has multiple gas discharge channels comprising the at least one gas discharge channel, wherein the gas discharge channels are arranged at a distance from one another, wherein one outlet opening of multiple outlet openings in each gas discharge channel opens into the gas discharge chamber, wherein a respective gas discharge channel has two gas-permeable channel walls lying opposite one another in the third direction.

26. The gas discharge chamber according to claim 13, wherein the gas distribution structure has multiple gas discharge channels comprising the at least one gas discharge channel, wherein the gas discharge channels are arranged at a distance from one another, wherein one outlet opening of multiple outlet openings in each gas discharge channel opens into the gas discharge chamber, wherein a respective gas discharge channel has two gas-permeable channel walls lying opposite one another in the third direction.

27. The gas discharge chamber according to claim 14, wherein the gas distribution structure has multiple gas discharge channels comprising the at least one gas discharge channel, wherein the gas discharge channels are arranged at a distance from one another, wherein one outlet opening of multiple outlet openings in each gas discharge channel opens into the gas discharge chamber, wherein a respective gas discharge channel has two gas-permeable channel walls lying opposite one another in the third direction.

28. The gas discharge chamber according to claim 15, wherein the gas distribution structure has multiple gas discharge channels comprising the at least one gas discharge channel, wherein the gas discharge channels are arranged at a distance from one another, wherein one outlet opening of multiple outlet openings in each gas discharge channel opens into the gas discharge chamber, wherein a respective gas discharge channel has two gas-permeable channel walls lying opposite one another in the third direction.

29. The gas discharge chamber according to claim 12, wherein the gas discharge chamber has at least one exposable second inlet opening at a position different from the first inlet opening, wherein the second inlet opening opens into the second region of the interior, in particular wherein the second inlet opening is associated with at least one second battery cell that is different from the at least one first battery cell.

30. The gas discharge chamber according to claim 13, wherein the gas discharge chamber has at least one exposable second inlet opening at a position different from the first inlet opening, wherein the second inlet opening opens into the second region of the interior, in particular wherein the second inlet opening is associated with at least one second battery cell that is different from the at least one first battery cell.
